(19) United States
(12) Patent Application Publication
(10) Pub. No.: US 2018/0313929 A1
(43) Pub. Date: Nov. 1, 2018

(54) USER EQUIPMENT POSITIONING

(71) Applicant: QUALCOMM Incorporated, San Diego, CA (US)

(72) Inventors: Suresh Kumar BITRA, Mangalagiri (IN); Arun Kumar Sharma TANDRA, Hyderabad (IN); Ashwin Kumar DONTHULA, Hyderabad (IN)

(21) Appl. No.: 15/498,140

(22) Filed: Apr. 26, 2017

(51) Int. Cl. G01S 5/02; H04W 64/00

(52) U.S. Cl. CPC G01S 5/0252; H04W 64/00; H04W 88/06; G01S 5/021; G01S 5/0221; G01S 5/0236

(57) ABSTRACT

A method of operating a user equipment (UE) that includes a first subscriber identification module (SIM) for communicating with a first wireless network and a second SIM for communicating with a second wireless network includes: receiving first assistance data and second assistance data determining to measure first positioning signals received from the first plurality of base stations of the first wireless network; selecting a measurement receiver of the UE to measure the first positioning signals; and measuring, using the measurement receiver and the first SIM, the first positioning signals. The first assistance data includes information about a first plurality of base stations of the first wireless network, and the second assistance data includes information about a second plurality of base stations of the second wireless network. The measurement receiver is selected from a shared receiver and a dedicated receiver of the UE.

### BACKGROUND

A User Equipment (UE)—such as a cellular phone, smart phone, tablet computer, laptop computer, smart watch, and other mobile device—may include multiple subscriber identity modules (SIM) thereby enabling the UE to communicate via multiple subscriptions to respective different wireless networks. A UE with multiple SIMs may be referred to as a “multi-SIM device.” Each SIM of the UE is associated with a respective subscription, which is an arrangement (e.g., a paid agreement) that gives the UE access to a particular carrier's network to enable the sending and receiving of multimedia data and voice information. Each SIM stores subscription information that is used by the UE to authenticate the SIM on the respective wireless network. A multi-SIM device where the multiple SIMs share a transceiver for communicating with the multiple networks is referred to as a “multi-SIM-multi-standby device.” An example is a device with two SIMs, referred to as a “dual-SIM-dual-standby (DSDS) device.” A multi-SIM device where each of the multiple SIMs has a respective dedicated transceiver for communicating with the respective network is referred to as a “multi-SIM-multi-active device.” An example is a device with two SIMs, each one of the two SIMs using a respective dedicated transceiver for communicating with the respective networks, referred to as a “dual-SIM-dual-active (DSDA) device.” In a DSDA device, both subscriptions may be active at the same time, as each SIM uses a dedicated transceiver, referred to as a primary transceiver, to communicate with the associated wireless network.

In addition to sending and receiving multimedia data and voice information to/from a wireless network, a UE may also be configured to perform positioning techniques to determine the location of the UE. For example, multilateration techniques may be used to determine the location of the UE. Performing multilateration requires the UE to receive and analyze signals from multiple known locations. One example of a positioning technique that uses multilateration is Observed Time Difference Of Arrival (OTDOA), which uses measurements of the difference in arrival times of positioning signals (e.g., positioning reference signals (PRS)) received by the UE from the multiple base stations to determine the location of the UE. In OTDOA, the UE uses assistance data received from a location server to measure the PRS. The UE sends measurement results to the location server, where the location of the UE is determined. However, there are other positioning techniques where the UE determines its own location. In such techniques, the assistance data provided to the UE may include information about the location of the base stations transmitting the positioning signals to the UE.

### SUMMARY

An example of a method of operating a user equipment (UE) that includes a first subscriber identification module (SIM) for communicating with a first wireless network and a second SIM for communicating with a second wireless network includes: receiving, from a tile information server, first assistance data and second assistance data, wherein the first assistance data includes information about a first plurality of base stations of the first wireless network, and wherein the second assistance data includes information about a second plurality of base stations of the second wireless network; determining, using a processor of the UE and based on the first assistance data and the second assistance data, to measure first positioning signals received from the first plurality of base stations of the first wireless network; selecting a measurement receiver of the UE to measure the first positioning signals, wherein the measurement receiver is selected from a plurality of receivers of the UE, the plurality of receivers comprising a shared receiver and a dedicated receiver, wherein the shared receiver is configured to use the first SIM or the second SIM, and wherein the dedicated receiver is configured to use only the first SIM; and measuring, using the measurement receiver and the first SIM, the first positioning signals.

Implementations of such a method may include one or more of the following features. The determining to measure the first positioning signals may be based on determining that a first positioning-quality value of the first wireless network is greater than a second positioning-quality value of the second wireless network. The determining that the first position-quality value is greater than the second positioning-quality value may include determining that a quantity of the first plurality of base stations is greater than a quantity of the second plurality of base stations. The determining that the quantity of the first plurality of base stations is greater than the quantity of the second plurality of base stations may include determining that a first quantity of the first plurality of base stations within an area in which the UE is located is greater than a second quantity of the second plurality of base stations within the area in which the UE is located. The determining that the first position-quality value is greater than the second positioning-quality value may include determining that a first location-error estimate based on the first plurality of base stations is less than a second location-error estimate based on the second plurality of base stations.

Implementations of such a method may also include one or more of the following features. The method may include disabling measurements of second positioning signals using the second SIM in response to the determining to measure the first positioning signals, wherein the second positioning signals are received from the second plurality of base stations of the second wireless network. The selecting the measurement receiver may include selecting the dedicated receiver that is dedicated to the first SIM. The selecting the measurement receiver to measure positioning signals may include selecting the shared receiver, wherein the shared receiver is a carrier aggregation receiver of the UE configured to receive carrier aggregation signals from the first wireless network or the second wireless network. The receiving the first assistance data and the second assistance data may include receiving location information for each base station of the first plurality of base stations and location information for each base station of the second plurality of base stations. The method may further include: establishing a dedicated data connection with the second wireless network using the second SIM; and maintaining the dedicated data connection with the second wireless network using the second SIM in response to the determining to measure the first positioning signals.

An example of a user equipment (UE) includes: a first subscriber identity module (SIM) configured to provide information that facilitates communication with a first wireless network; a second SIM configured to provide information that facilitates communication with a second wireless network; a plurality of receivers; and a processor communicatively coupled to the first receiver, the first SIM, the second receiver and the second SIM. The plurality of receivers include: a first receiver configured to receive information from the first wireless network using the first SIM; a second receiver configured to receive information from the second wireless network using the second SIM; and a shared receiver configured to receive information from the first wireless network using the first SIM and configured to receive information from the second wireless network using the second SIM. The processor is configured to: receive, from a tile information server, first assistance data and second assistance data, wherein the first assistance data includes information about a first plurality of base stations of the first wireless network, and wherein the second assistance data includes information about a second plurality of base stations of the second wireless network; determine, based on the first assistance data and the second assistance data, to measure first positioning signals received from the first plurality of base stations of the first wireless network; select a measurement receiver, from among the plurality of receivers, to measure the first positioning signals; and control the measurement receiver and the first SIM to measure the first positioning signals.

Implementations of such a method may include one or more of the following features. The processor may be configured to determine to measure the first positioning signals based on a determination that a first positioning-quality value of the first wireless network is greater than a second positioning-quality value of the second wireless network. The processor may be configured to determine that the first position-quality value is greater than the second positioning-quality value by determining that a quantity of the first plurality of base stations is greater than a quantity of the second plurality of base stations. The processor may be configured to determine that the quantity of the first plurality of base stations is greater than the quantity of the second plurality of base stations by determining that a first quantity of the first plurality of base stations within an area in which the UE is located is greater than a second quantity of the second plurality of base stations within the area in which the UE is located. The processor may be configured to determine that the first position-quality value is greater than the second positioning-quality value by determining that a first location-error estimate based on the first plurality of base stations is less than a second location-error estimate based on the second plurality of base stations.

Implementations of such a UE may also include one or more of the following features. The processor may be configured to disable measurements of second positioning signals using the second SIM in response to a determination to measure the first positioning signals, wherein the second positioning signals are received from the second plurality of base stations of the second wireless network. The processor may be configured to select the first receiver as the measurement receiver. The shared receiver may include a carrier aggregation receiver configured to receive carrier aggregation signals from the first wireless network or the second wireless network; and the processor may be configured to select the carrier aggregation receiver as the measurement receiver. To receive the first assistance data and the second assistance data the processor may be configured to receive location information for each base station of the first plurality of base stations and location information for each base station of the second plurality of base stations. The processor may be further configured to: establish a dedicated data connection with the second wireless network using the second SIM; and maintain the dedicated data connection with the second wireless network using the second SIM in response to a determination to measure the first positioning signals.

An example of a user equipment (UE) includes: a first subscriber identity module (SIM) configured to provide information that facilitates communication with a first wireless network; a second SIM configured to provide information that facilitates communication with a second wireless network; a plurality of receivers, including: a first receiver configured to receive information from the first wireless network using the first SIM, a second receiver configured to receive information from the second wireless network using the second SIM, and a shared receiver configured to receive information from the first wireless network using the first SIM and configured to receive information from the second wireless network using the second SIM; means for receiving, from a tile information server, first assistance data and second assistance data, wherein the first assistance data includes information about a first plurality of base stations of the first wireless network, and wherein the second assistance data includes information about a second plurality of base stations of the second wireless network; means for determining, based on the first assistance data and the second assistance data, to measure first positioning signals received from the first plurality of base stations of the first wireless network; means for selecting a measurement receiver, from among the plurality of receivers, to measure the first positioning signals; and means for controlling the measurement receiver and the first SIM to measure the first positioning signals.

Implementations of such a UE may include one or more of the following features. The means for determining to measure the first positioning signals may include means for determining that a first positioning-quality value of the first wireless network is greater than a second positioning-quality value of the second wireless network. The UE may further include means for disabling measurements of second positioning signals using the second SIM in response to a determination to measure the first positioning signals, wherein the second positioning signals are received from the second plurality of base stations of the second wireless network. The shared receiver may include a carrier aggregation receiver configured to receive carrier aggregation signals from the first wireless network or the second wireless network; and the means for selecting the measurement receiver may include means for selecting the carrier aggregation receiver as the measurement receiver. The UE may further include means for establishing a dedicated data connection with the second wireless network using the second SIM; and means for maintaining the dedicated data connection with the second wireless network using the second SIM in response to a determination to measure the first positioning signals.

An example of a non-transitory processor-readable storage medium includes processor-readable instructions configured to cause a processor of a user equipment (UE), which includes a first subscriber identification module (SIM) for communicating with a first wireless network and a second SIM for communicating with a second wireless network, to: receive, from a tile information server, first assistance data and second assistance data, wherein the first assistance data includes information about a first plurality of base stations of the first wireless network, and wherein the second assistance data includes information about a second plurality of base stations of the second wireless network; determine, based on the first assistance data and the second assistance data, to measure first positioning signals received from the first plurality of base stations of the first wireless network; select a measurement receiver of the UE to measure the first positioning signals, the plurality of receivers comprising a shared receiver and a dedicated receiver, wherein the shared receiver is configured to use the first SIM or the second SIM, and wherein the dedicated receiver is configured to use only the first SIM; and control the measurement receiver and the first SIM to measure the first positioning signals.

Implementations of such a non-transitory processor-readable storage medium may include one or more of the following features. The instructions configured to cause the processor to determine to measure the first positioning signals may include instructions configured to cause the processor to determine that a first positioning-quality value of the first wireless network is greater than a second positioning-quality value of the second wireless network. The non-transitory processor-readable storage medium may include instructions configured to cause the processor to disable measurements of second positioning signals using the second SIM in response to a determination to measure the first positioning signals, wherein the second positioning signals are received from the second plurality of base stations of the second wireless network. The instructions configured to cause the processor to select the measurement receiver may include instructions configured to cause the processor to selecting the shared receiver as the measurement receiver, wherein the shared receiver is a carrier aggregation receiver configured to receive carrier aggregation signals from the first wireless network or the second wireless network. The non-transitory processor-readable storage medium may include instructions configured to cause the processor to: establish a dedicated data connection with the second wireless network using the second SIM; and maintain the dedicated data connection with the second wireless network using the second SIM in response to a determination to measure the first positioning signals.

### BRIEF DESCRIPTION OF THE DRAWINGS

FIG. 1 is a simplified diagram of an example communications environment.

FIG. 2 is a block diagram of an example UE shown in FIG. 1.

FIG. 3 is an example of assistance data that may be received by the UE of FIG. 2.

FIG. 4 is an example of tile information that may be received by the UE of FIG. 2.

FIG. 5 is a simplified diagram of an example communications environment with base stations of two different wireless networks.

FIG. 6 is a diagram illustrating an example location error estimate for a particular geometry of five base stations.

FIG. 7 is a block flow diagram of an example method of operating the UE of FIG. 2.

### DETAILED DESCRIPTION

Techniques are discussed herein for performing positioning techniques by selecting a receiver and a SIM of a UE to measure received positioning signals. A multi-SIM device may measure positioning signals using any available SIM and any available receiver of the multi-SIM device. The UE may determine which SIM and which receiver to use to make the measurements based on which wireless network subscription is likely to provide better positioning quality. For example, if the UE includes multiple SIMs, with each SIM configured to communicate with a respective wireless network, the UE may select the wireless network with a largest quantity of base stations, or the highest base station density in the vicinity of the UE, to perform the positioning measurements. Alternatively, the UE may select a network to use based on a location-error estimate such as the geometrical dilution of precision (GDOP) for each available wireless network. The UE may also select a receiver, which may be a receiver dedicated to the SIM associated with the selected wireless network or a shared receiver that may be used with any available SIM, to measure the positioning signals.

The UE may determine which wireless network to use for determining the location of the UE based on assistance data received from a tile information server that is different from the location servers of the wireless networks. A “tile” refers to an area (for example, a one square kilometer area) that, together with other tiles, cover a geographic area of an environment in which the UE operates. The assistance data received from the tile information server is referred to as tile information. The tile information may include information about positioning signals and/or locations of base stations of the wireless networks to which the UE has subscriptions or one or more other wireless networks to which the UE does not have a subscription. The locations of the respective base stations (i.e., base station location information) for each wireless network with which the UE has a subscription may be used to determine a positioning-quality value for each wireless network. The UE may select from which base stations to measure positioning signals based on the base station location information provided by the tile information server.

The positioning technique implemented by the UE may be a positioning technique such as OTDOA, where the UE determines the time difference of arrival times for positioning signals received from various base stations. For example, the UE may receive positioning reference signals (PRS) or cell-specific reference signals (CRS) from nearby base stations. The UE determines a Reference Signal Time Difference (RSTD) value using time-of-arrival measurements of the received PRS from multiple base stations of the selected wireless network. The RSTD results are transmitted to a location server of the selected wireless network, where the location of the UE is determined. Alternatively, other positioning techniques may be implemented by the UE. For example, using the base station location information received from the tile information server, the UE itself may determine its own location with or without sending measurement results back to a location server.

The UE may have a dedicated data subscription that is set, e.g. by a user of the UE, as the default subscription for sending and receiving data, such as multimedia data. Using the dedicated data subscription may include using a SIM associated with the dedicated data subscription and a receiver associated with the dedicated data subscription to perform the measurement of positioning signals. Techniques discussed herein perform location determination by selecting a wireless network determined to have an arrangement of base stations in the vicinity of the UE that is desirable, e.g., that will result in less location error than using another wireless network.

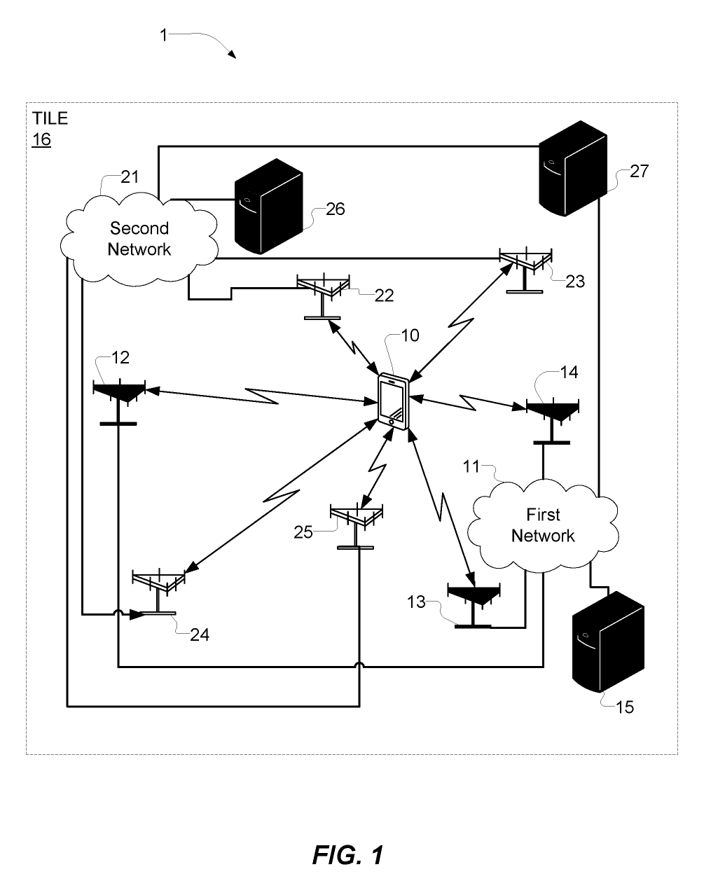

Referring to FIG. 1, a communications environment 1 includes a UE 10, a first network 11 a second network 21, and a tile information server 27. The first network 11 includes base stations 12-14, though, for the sake of clarity, the base stations 12-14 are shown separate from the first network 11 in FIG. 1. The second network 21 includes base stations 22-25, though for the sake of clarity, the base stations 22-25 are shown separate from the second network 21. Each of the base stations 12-14, 22-25 may be a wireless base transceiver station (BTS), a Node B, an evolved NodeB (eNB), a femtocell, a Home Base Station, a small cell base station, a Home Node B (HNB), a Home eNodeB (HeNB), etc. The first network 11 and the second network 21 may each be a 2G, a 3G, a 4G, or a 5G network, or be a hybrid network (e.g., a 3G/4G network). The first network 11 need not be the same type of network as the second network 21 and may be operated by different carriers or a single carrier. The base stations 12-14, 22-25 of the two networks 11, 21 may wirelessly communicate with the UE 10 using one or more radio access technologies (RATs), such as GSM (Global System for Mobile Communications), code division multiple access (CDMA), wideband CDMA (WCDMA), Time Division CDMA (TD-CDMA), Time Division Synchronous CDMA (TDS-CDMA), CDMA2000, High Rate Packet Data (HRPD), or long term evolution (LTE). These are examples of network technologies that may be used to communicate with the UE 10 over a wireless link, and claimed subject matter is not limited in this respect. GSM, WCDMA and LTE are technologies defined by the 3GPP. CDMA and HRPD are technologies defined by the 3rd Generation Partnership Project 2 (3GPP2). WCDMA is also part of the Universal Mobile Telecommunications System (UMTS) and may be supported by an HNB. Additionally, both the first network 11 and the second network 21 may support more than one RAT. For example, the first network 11 may communicate with the UE 10 using both W-CDMA and LTE. Additionally, the first network 11 and the second network 21 may communicate with the UE 10 using the same RAT. For example, the first network 11 and the second network 21 may both send and receive signals to the UE 10 using LTE. Further, while three base stations are illustrated in FIG. 1 for the first network 11 and four base stations are illustrated for the second network 21, different numbers of base stations may be used.

The base stations 12-14 are communicatively coupled to other portions of the first network 11 using, for example, a physical connection, such as a wired or optical connection. The base stations 22-25 are communicatively coupled to other portions of the second network 21 using, for example, a physical connection, such as a wired or optical connection. For example, in situations where a particular network is an LTE network, the other portions of the particular network may include, but are not limited to, a packet data network gateway, a mobility management entity, a serving gateway, and additional base stations.

The first network 11 further includes a location server 15, and the second network 21 further includes a location server 26, though for the sake of clarity, the location server 15 and the location server 26 are shown separate from the first network 11 and the second network 21, respectively. The location server 15 and the location server 26 may each be one of a variety of server types. For example, each of the location servers 15, 26 may be an Evolved Serving Mobile Location Centre (E-SMLC), a Secure User Plane Location (SUPL) Location Platform (SLP), a SUPL Location Center (SLC), a SUPL Positioning Center (SPC), a Position Determining Entity (PDE) and/or a gateway mobile location center (GMLC), each of which may connect to one or more location retrieval functions (LRFs) and/or mobility management entities (MMEs).

The two networks 11, 21 are cellular communications networks that allow the UE 10 to send and receive telephone calls and data. The first network 11 uses the base stations 12-14 to wirelessly send information to and receive information from the UE 10 and/or other UEs not shown in FIG. 1. The second network 21 uses the base stations 22-25 to wirelessly send information to and receive information from the UE 10 and/or other UEs not shown in FIG. 1. In some examples, the UE 10 may only be able to send and receive telephone calls and data via the first network 11, but not the second network 21. In such a situation, however, the UE 10 may still be configured to receive and measure positioning signals sent by the base stations 22-25 of the second network 21. Each of the base stations 12-14, 22-25 provides a wireless communications service to UEs within a particular area referred to as a “cell.” Each of the base stations 12-14, 22-25 transmits radio frequency (RF) signals to, and receives RF signals from, UEs within a respective cell.

The location servers 15, 26 store assistance data for the first network 11 and the second network 21, respectively. The assistance data stored on the location server 15 may include information about the base stations 12-14 of the first network 11, and not the base stations 22-25 of the second network 21, whereas the assistance data stored on the location server 26 may include information about the base stations 22-25 of the second network 21, but not the base stations 12-14 of the first network 11. The assistance data may be used be the UE 10 for performing one or more positioning techniques to determine the location of the UE 10.

The tile information server 27 stores information about base stations located in an area. The stored information is referred to as “tile information” and is a form of assistance data that may be used by the UE 10 to perform positioning techniques. In contrast to the location servers 15, 26, the tile information server 27 is not considered to be part of either the first network 11 or the second network 21. The tile information server 27 may be operated by an entity different from the carrier that operates the first network 11 and different from the carrier that operates the second network 21. By way of example and not limitation, the tile information server 27 may be owned and/or operated by a UE manufacturer, a manufacturer of UE components (e.g., chips), or one or more other third parties (i.e., entities other than the carrier that controls the wireless network). Whereas the assistance data stored on a location server of a particular network is specific to that network, the tile information stored on the tile information server 27 includes information about both the first network 11 and the second network 21. The tile information may be accumulated by the tile information server 27 via crowd-sourced data gathered from multiple UEs. For example, UEs made by a particular manufacturer, or UEs that include chips made by particular manufacturer, may send information related to the positioning signals and/or base stations of a wireless network to the tile information server 27. The UEs used to crowd source the tile information may communicate with different wireless networks. Therefore, the tile information gathered by the tile information server 27 is not limited to one particular network, but may include information about the positioning signals and/or the base stations of multiple wireless networks. For example, the UE 10 of FIG. 1 may only communicate with the location server 15 of the first network 11, but the tile information received from the tile information server 27 may include information about the base stations 12-14 of the first network 11 and the base stations 20-25 of the second wireless network 21.

The communications environment 1 is broken into regions referred to as tiles. FIG. 1 illustrates a single tile 16 that includes the base stations 12-14 of the first network 11 and base stations 22-25 of the second network 21. The tile may be, for example, a 1 km by 1 km square, but other sizes and shapes of tile may be used. For example, tiles may have the shape of a triangle, rectangle, polygon, etc. While FIG. 1 illustrates the location server 15, the location server 26, the tile information server 27, and the networks 11, 21 within the tile 16, one or more, including possibly all, of the servers 15, 26, 27 and/or the networks 11, 21 may be located at any geographic location including outside of the area of the tile 16. Additionally, some portions of the networks 11, 21 may be within the area of the tile 16 and other portions of the networks 11, 21 may be located outside of the area of the tile 16. The UE 10 receives tile information for the base stations within the tile that the UE 10 occupies, here the tile 16. The UE 10 may also receive assistance data for other tiles near the UE 10, including neighboring tiles.

When in the communications environment 1, the UE 10 receives a variety of wireless signals from the base stations 12-14 and the base stations 22-25. The UE 10 is said to “camp” to a particular base station when the base station is selected by the UE 10 as the primary base station (sometimes referred to as the serving base station or the serving cell) for communications with the respective wireless network. For example, the UE 10 may be camped to the base station 13 of the first network 11, resulting in the UE 10 monitoring paging messages from the base station 13 and sending information to the base station 13 for maintaining and managing the connection to the first network 11. The primary base station may change as the UE 10 moves throughout the communications environment 1. For example, as the UE 10 moves towards the base station 12, the UE 10 may handover the role of primary base station to the base station 12.

The primary base station (e.g., the base station 14 of the first network 11) sends the assistance data to the UE 10 for use in performing one or more positioning techniques. The assistance data originates from a location server 15 of the first network 11. The assistance data include information about the positioning signals that the UE 10 is expected to receive from the primary base station 14 as well as the other base stations 12-13 of the first network 11, but does not include information about positioning signals transmitted by the base stations 22-25 of the second network 21. Additionally, the location server 15 may send assistance data for less than all of the base stations of the first network 11. The location server 15 may select a subset of the base stations of the first network 11 and send assistance data for the subset of base stations only. If the UE 10 is camped to a primary base station (e.g., base station 24) of the second network 21, then a location server 26 of the second network 21 sends assistance data for the second network 21 to the UE 10 via the base station 24.

For each of the base stations whose information is included in communications received by the UE 10 from location server 15, the assistance data includes at least an indication of the identity of each base station, an indication of the frequency channel (corresponding to an RF band) that each base station will use to send a respective positioning signal, and an indication of the time at which the respective positioning signal is expected to be received by the UE 10. The indication of the time at which the positioning signal is expected to be received may include an indication of the location of the positioning signal within a frame received from a base station. The indication of the location of the positioning signal within a frame may be an indication of a periodicity of the positioning signal (e.g., measured in milliseconds or number of sub-frames), an indication of a sub-frame offset value of the positioning signal, and an indication of the duration of the positioning signal (e.g., measured in milliseconds or number of sub-frames). In an implementation for the case of OTDOA, the positioning signals are positioning reference signals (PRS), as defined by the LTE standard. Information about the location of the base stations that are expected to send the PRS signals may not be included in the OTDOA assistance data, e.g., because the determination of the location of the UE 10 using OTDOA may occur on the network side (e.g., on the server 15 or the server 26), not on the UE 10 and thus the UE 10 may not need this information. When performing OTDOA, the UE 10 makes time difference measurements that are used by the location server 15 to determine the location of the UE 10.

The UE 10 is configured to perform at least a portion of a positioning technique. For example, the UE 10 may perform time of arrival measurements that may be used to, for example, determine an RSTD value by determining time differences between the arrival times of positioning signals received from multiple base stations. When the location technique being performed by the UE 10 is OTDOA, measurement results from the measurements are sent to the location server 15 to determine the location of the UE 10. The positioning techniques used by the UE 10, however, are not limited to OTDOA. For example, positioning protocols such as the terrestrial downlink positioning (TDP) of Qualcomm® may be performed by the UE 10 to determine the location of the UE 10 based on a time-of-arrival and/or time-difference-of-arrival of positioning signals from multiple nearby base stations. TDP differs from OTDOA in a number of ways. First, in TDP the location determination is performed by the UE 10, not by the location server 15 or some other server, as is the case for OTDOA. By determining the location of the UE 10 locally, the UE 10 may forego sending measurement results to an external server. But to determine the location locally, the UE 10 uses additional information that is not included in the assistance data received from the location server 15. Specifically, the UE 10 uses information about the location of the base stations, which may be included in the tile information received from the tile information server 27. Second, TDP is not limited to using signals from base stations operated by a single carrier. By providing the UE 10 access to the tile information, which includes information about base stations of multiple networks, the number of base stations available for positioning is increased.

The inventors have recognized and appreciated that, in addition to being used to perform TDP, the tile information may also be used to aid in intelligently selecting a wireless network for determining the location of the UE 10. For example, the tile information can be used by the UE 10 to determine a positioning-quality value for each of the available wireless networks and select the wireless network with the highest position-quality value for determining the location of the UE 10.

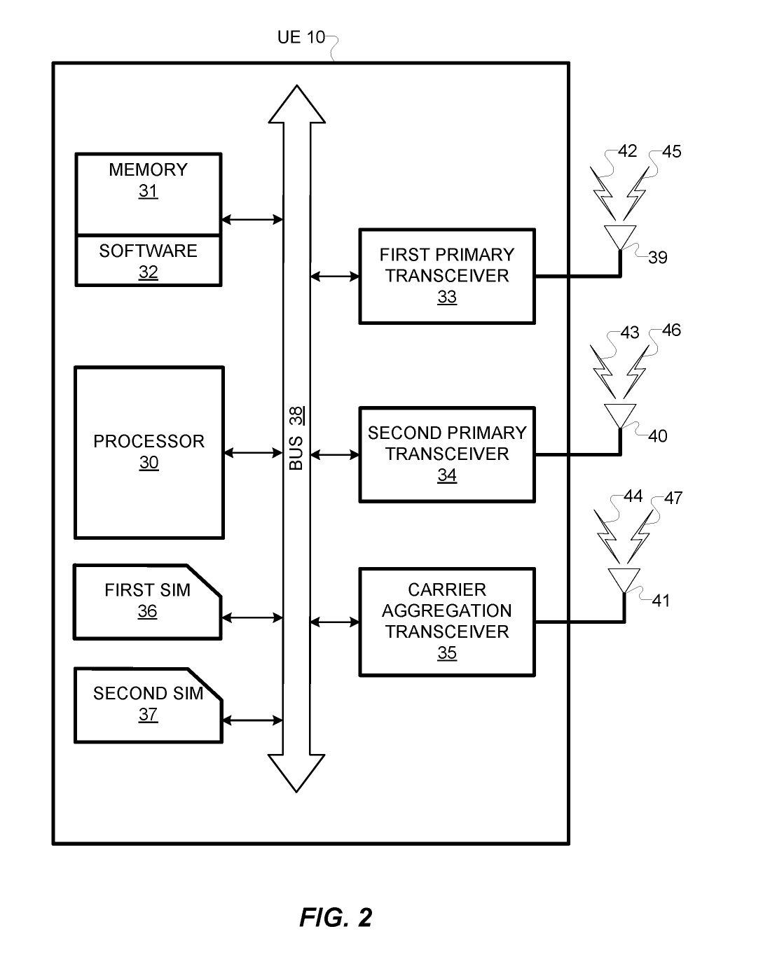

Referring to FIG. 2, with further reference to FIG. 1, an example of the UE 10 includes a processor 30, a memory 31 with software 32 stored thereon, a first SIM 36, a second SIM 37, a first primary transceiver 33, a second primary transceiver 34 and a carrier aggregation transceiver 35. The first primary transceiver 33, the second primary transceiver 34 and the carrier aggregation transceiver 35 may be collectively referred to as “the transceivers 33-35.” The UE 10 is a computer system that may be a handheld mobile device, such as a mobile phone or a smart phone. The processor 30 is an intelligent device, e.g., a central processing unit (CPU) such as those made or designed by Qualcomm®, ARM®, Intel® Corporation, or AMD®, a microcontroller, an application specific integrated circuit (ASIC), etc. The memory 31 is a non-transitory, processor-readable memory that stores instructions, such as software 32, that may be executed by processor 30 and includes random access memory (RAM), read-only memory (ROM) and non-volatile memory such as flash memory or solid state storage. The software 32 can be loaded onto the memory 31 by being downloaded via a network connection, uploaded from a disk, etc. Further, the software 32 may not be directly executable, e.g., requiring compiling before execution. The software 32 includes instructions configured to cause the processor 30 to perform functions described herein.

The first SIM 36 and the second SIM 37 are separate and distinct SIMs that are configured to provide information to the receivers 33-35 to access a respective network using a respective subscription. The SIMs 36-37 may be, for example, a Universal Integrated Circuit Card (UICC) and may include a processor, ROM, RAM, Electrically Erasable Programmable Read-Only Memory (EEPROM) and/or circuitry. The first SIM 36 and the second SIM 37 are configured to store user account information, an international mobile subscriber identity (IMSI), SIM application toolkit (SAT) command instructions, and additional information, such as telephone book contact information.

The various components of the UE 10 are communicatively coupled to one another via a bus 38, which is configured to transmit information from one component to another component. For example, the processor 30 is communicatively coupled to the transceivers 33-35, the SIMs 36-37, and the memory 31 via the bus 38. The processor 30 is configured to control the operations of the transceiver 33-35 and the SIMs 36-37 by sending commands and information to the transceivers 33-35 and the SIMs 36-37 via the bus 38. Additionally, the transceivers 33-35 are configured to send information wirelessly received from a base station of a wireless network to the processor 30 via the bus 38.

The first primary transceiver 33 is dedicated to the first SIM 36, which means that the first primary transceiver 33 only communicates with the first network 11 using the first SIM 36 and does not use any other SIM (e.g., the second SIM 37) to communicate to any other wireless network (e.g., the second network 21). The first primary transceiver 33 is configured to transmit, via an antenna 39, wireless signals 42 that are intended to be received by one or more base stations of the first network 11. For example, the first primary transceiver 33 may send measurement results, such as RSTD results, intended for the location server 15 to the primary base station 14 of the first network 11. Consequently, the first primary transceiver 33 may be considered a wireless transmitter. The first primary transceiver 33 is also configured to receive wireless signals 45, sent by one or more base stations, via the antenna 39. Consequently, the first primary transceiver 33 may be considered a wireless receiver. As an example, the wireless signals 35 may include a positioning signal received from one or more of the base stations 12-14. The first primary transceiver 33 is configured to receive the positioning signal and to measure one or more properties of the positioning signal. For example, the first primary transceiver 33 may determine the time of arrival of the positioning signal relative to a clock of the first primary transceiver 33. Alternatively, or additionally, the first primary transceiver 33 may determine the time difference of arrival of two different positioning signals from two different base stations. Furthermore, the first primary transceiver 33 may be configured to receive tile information from the tile information server 27 and the assistance data associated with the base stations 12-14 of the first network 11 from the location server 15. While the first primary transceiver 33 is shown separate from the processor 30, the first primary transceiver 33 may include one or more processors for performing the actions described herein as being performed by the processor 30.

The second primary transceiver 34 is dedicated to the second SIM 37, which means that the second primary transceiver 34 only communicates with the second network 21 using the second SIM 37 and does not use any other SIM (e.g., the first SIM 36) to communicate to any other wireless network (e.g., the first network 11). The second primary transceiver 34 is configured to transmit, via an antenna 40, wireless signals 43 that are intended to be received by one or more base stations of the second network 21. For example, the second primary transceiver 34 may send measurement results, such as RSTD results, intended for the location server 26 to a primary base station 23 of the second network 21. Consequently, the first primary transceiver 33 may be considered a wireless transmitter. The second primary transceiver 34 is also configured to receive wireless signals 46, sent by one or more base stations, via the antenna 40. Consequently, the first primary transceiver 33 may be considered a wireless receiver. As an example, the wireless signals 46 may include a positioning signal received from one or more of the base stations 22-25. The second primary transceiver 34 is configured to receive the positioning signal and to measure one or more properties of the positioning signal. For example, the second primary transceiver 34 may determine the time of arrival of the positioning signal relative to a clock of the second primary transceiver 34. Alternatively, or additionally, the second primary transceiver 34 may determine the time difference of arrival of two different positioning signals from two different base stations. Furthermore, the second primary transceiver 34 may be configured to receive tile information from the tile information server 27 and the assistance data associated with the base stations 22-25 of the second network 21 from the location server 26. While the second primary transceiver 34 is shown separate from the processor 30, the second primary transceiver 34 may include one or more processors for performing the actions described herein as being performed by the processor 30.

The carrier aggregation transceiver 35 is a shared transceiver that is configured to act as a wireless transmitter and a wireless receiver. The carrier aggregation transceiver 35 is considered a shared transceiver because the carrier aggregation transceiver 35 is configured to wirelessly receive signals from the first network 11 using a first SIM 36 and/or the second network 21 using the second SIM 37. The UE 10 may include more than one carrier aggregation transceiver, though only the single carrier aggregation transceiver 35 is illustrated. The carrier aggregation transceiver 35 is conventionally reserved for applications where increased bandwidth is desired. For example, if a user of the UE 10 is downloading a video or an audio file, the number of bits received by the UE 10 may be increased by operating the carrier aggregation transceiver 35 in parallel with one of the primary transceivers 33, 34. This parallel operation of multiple transceiver is referred to as “carrier aggregation.” When carrier aggregation is used, the primary base station assigns secondary carrier components (CC), which are additional channels for transmitting information to the UE. The CC channels may be utilized by the primary base station or other neighboring base stations. When the number of CC channels increases, the number of transceivers used by the UE increases due to there being a one-to-one correspondence between the number of transceivers and the number of base stations. For example, the first network 11 may determine that the network 11 is sending a large file to the UE 10 and therefore activate carrier aggregation. The first network 11 uses the primary base station to send information about the carrier aggregation implementation (e.g., information about the CC channels) to the first primary transceiver 33 of the UE 10. The UE 10 and the first network 11 establish, using the first SIM 36, a connection between the carrier aggregation transceiver 35 and a CC channel associated with a secondary base station of the first network 11. The UE 10 receives the file via both the first primary transceiver 33 and the carrier aggregation transceiver 35, in parallel, thereby decreasing the amount of time required to receive the file. The carrier aggregation transceiver 35 differs from the first primary transceiver 33 in that the carrier aggregation transceiver 35 never acts as a primary receiver for managing the UE's connection to the primary base station of the first network 11.

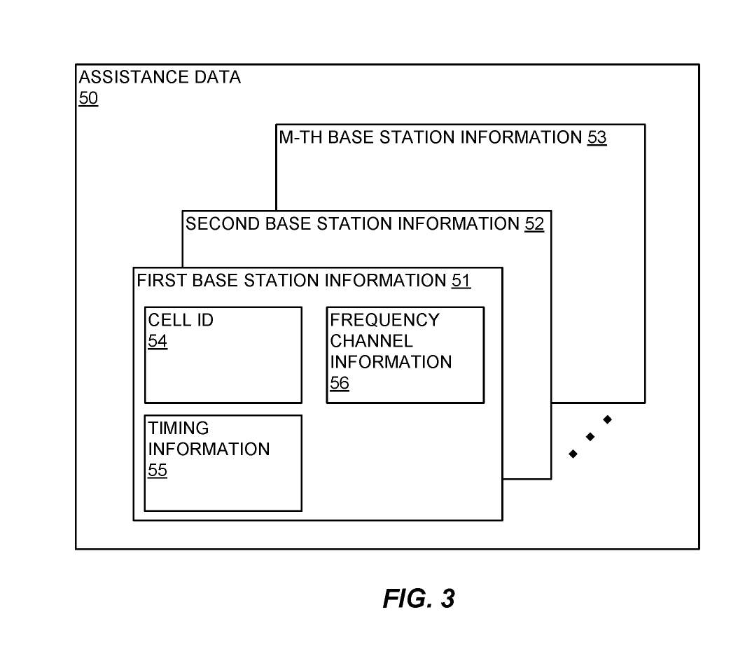

Referring to FIG. 3, with further reference to FIGS. 1-2, an example of the assistance data received by the first primary transceiver 33 and/or the second primary transceiver 34 is the assistance data 50, which includes information for use by the UE 10 for performing one or more positioning techniques. The assistance data 50 is representative of the assistance data sent by the location server 15 of the first network 11 and the assistance data sent by the location server 26 associated with the second network 21. The assistance data 50 includes information about multiple base stations of the associated network. For example, the assistance data 50 includes first base station information 51, second base station information 52, and m-th base station information 53, where m is the total number of base stations for which information is provided by the assistance data 50. Base station information is also provided for any other base station between the second base station and the m-th base station (not shown). For the sake of simplicity and clarity, FIG. 3 only illustrates details for the first base station information 51. The information associated with the other base stations may be the same type of information as the first base station information 51, or it may be different.

The first base station information 51 includes a cell identification (ID) 54, timing information 55 and frequency channel information 56, but additional information may be included. An example of a cell ID 54 is an identifier that the UE 10 and the first network 11 use to identify and/or address a particular base station. The timing information 55 includes an estimate of when the UE 10 is expected to receive a positioning signal. For example, the timing information 55 may include a periodicity, a timing offset and a duration of a positioning signal emitted by the base station. Alternatively or additionally, the timing information 55 may include an indication of a specific time that a particular positioning signal is expected to arrive at the UE 10. The frequency channel information 56 includes an indication of a frequency band on which the positioning signal will be transmitted by the base station. The timing information 55 and frequency channel information 56 may be used by the processor 30 of the UE 10 to control the times and frequency channels that the wireless transceiver 33 searches for the positioning signal for measurement.

The second base station information 52 and the m-th base station information 53 may include information similar to the first base station information 51, but for respective signals from respective base stations.

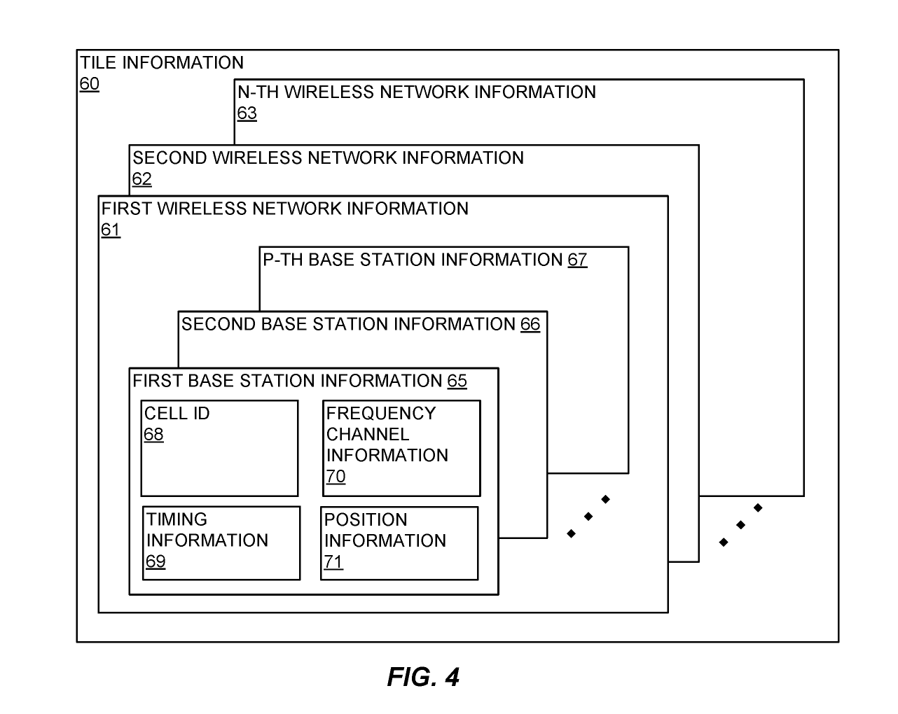

Referring to FIG. 4, with further reference to FIGS. 1-3, an example of the tile information received by the first primary transceiver 33 and/or the second primary transceiver 34 is tile information 60, which includes information for use by the UE 10 for performing one or more positioning techniques. The tile information 60 is representative of the tile information sent by the tile information server 27 and includes information about the first network 11, the second network 21, and, optionally, one or more other wireless networks. For example, the tile information 60 includes first wireless network information 61, second wireless network information 62, and n-th wireless network information 63, where n is the total number of wireless networks for which information is provided by the tile information 60. For the sake of simplicity and clarity, FIG. 4 only illustrates details for the first wireless network information 61. The information associated with the other wireless networks may be the same type of information as the first wireless network information 61, or it may be different. The first wireless network information 61 may be referred to as first assistance data and the second wireless network information 62 may be referred to as second assistance data.

The first wireless network information 61 includes information about multiple base stations of the first network 11. For example, the first wireless network information 61 includes first base station information 65, second base station information 66, and p-th base station information 67, where p is the total number of base stations of the first network 11 for which information is provided by the tile information 60. Base station information is also provided for any other base station between the second base station and the p-th base station (not shown). For the sake of simplicity and clarity, FIG. 4 only illustrates details for the first base station information 61. The information associated with the other base stations may be the same type of information as the first base station information 61, or it may be different.

The first base station information 61 includes a cell ID 68, timing information 69, frequency channel information 70, and a position information 71, but additional information may be included. An example of a cell ID 68 is an identifier that the UE 10 and the first network 11 use to identify and/or address a particular base station. The timing information 69 includes an estimate of when the UE 10 is expected to receive a positioning signal. For example, the timing information 69 may include a periodicity, a timing offset and a duration of a positioning signal emitted by the base station. Alternatively or additionally, the timing information 69 may include an indication of a specific time that a particular positioning signal is expected to arrive at the UE 10. The frequency channel information 70 includes an indication of a frequency band on which the positioning signal will be transmitted by the base station. The timing information 69 and frequency channel information 70 may be used by the processor 30 of the UE 10 to control the times and frequency channels that the wireless transceiver 33 should search for the positioning signal for measurement. The position information 71 includes an indication of the position of the base station associated with the first base station information 65. The UE 10 or the location server 15 can use the position information 71 in connection with RSTD values determined by the UE 10, or another measurement based on the time of arrival or time difference of arrival of signals from the first signal emitter and other signal emitters, to approximate the location of the UE 10. By way of example and not limitation, the position information 71 may include a latitude value, a longitude value, and an altitude value for the base station. Alternatively or additionally, the position information 71 may include an identification of a tile in which the base station is located.

The second base station information 66 and the p-th base station information 67 may include information similar to the first base station information 65, but for respective signals from respective base stations.

Returning to FIG. 2, with further reference to FIGS. 1 and 3-4, the processor 30 is configured to receive, from the tile information server 27, first assistance data and second assistance data, where the first assistance data includes information about first base stations of the first wireless network, and where the second assistance data includes information about second base stations of the second wireless network. By way of example and not limitation, the first base stations may be the base stations 12-14 of the first network 11 and the second base stations may be the base stations 22-25 of the second network 21. Additionally, the first assistance data may include the first wireless network information 61, which includes cell IDs and position information for multiple base stations of the first network 11 and timing information and frequency channel information for positioning signals transmitted by each of the multiple base stations of the first network 11. Similarly, the second assistance data may include the second wireless network information 62 which includes cell IDs and position information for multiple base stations of the second network 21 and timing information and frequency channel information for positioning signals transmitted by each of the multiple base stations of the second network 21.

The processor 30 is further configured to determine, based on the first assistance data and the second assistance data, to measure first positioning signals received from the first base stations of the first wireless network. For example, the processor 30 may be configured to analyze the assistance data associated with the first network 11 and the assistance data associated with the second network 21 in order to determine a metric by which the networks can be compared. An example metric may be a positioning-quality value used by the UE 10 to determine which of the available wireless networks is likely to result in the highest quality result from a positioning technique, e.g., a position with the highest accuracy and/or the lowest error and/or the lowest uncertainty. The positioning-quality value need not be a direct measure of quality. Instead the quality of the result may be inferred from some other property. If the processor 30 determines that the positioning-quality value for a first network is equal to the positioning-quality value of a second network (and they are both the highest positioning-quality values from among the available networks), the processor 30 may select which network to use based on some other criterion (or criteria). For example, the processor 30 may select the wireless network associated with a dedicated data connection. Alternatively, a default positioning network may be selected. The default positioning network may be identified by the UE 10 manufacturer, the user of the UE, or some other entity and stored in the memory 31 of the UE 10.

One example of a positioning-quality value may be a quantity of base stations of a respective network. The processor 30 may be configured to determine that the first network 11 has fewer base stations than the second network 21. The processor 30 may determine to measure, in response to such a determination, the positioning signals received from the base stations of the second network 21 rather than measure the positioning signals received from the base stations of the first network 11. The quantity of base stations may be a total number of base stations, a number of base stations the UE 10 receives signals from or some other quantity of base stations. By way of example, the number of base stations the UE 10 receives signals from may include all base stations from which the UE 10 receives a signal at a particular time or only base stations from which the UE 10 receives a signal at a particular time for which the strength and/or quality of the signal exceeds a threshold. An example of a measure of the strength of a signal is a received signal strength indicator (RSSI), which is a measurement of the power present in a received signal, as measured by the UE 10. Examples of measures of quality of a signal is a reference signal received quality (RSRQ) or a signal to noise ratio (SNR). Any combination of RSSI, RSRQ, or SNR may be used to determine if a base station is “in communication” with the UE 10. For example, if the RSSI of a received signal is greater than an RSSI-threshold, the RSRQ is greater than an RSRQ-threshold and the SNR is greater than an SNR-threshold, then the processor 30 determines that the base station from which the signal was received is in communication with the UE 10. On the other hand, if one of the RSSI, the RSRQ, or the SNR of a signal is less than the respective threshold, the base station from which the signal was received is not considered “in communication” with the UE 10. In other example implementations, only one or two of RSSI, RSRQ, and SNR are used to determine whether a base station is in communication with the UE 10. In response to the UE 10 determining that it will perform a positioning technique, the processor 30 may compare a quantity of base stations of the first network 11 that are in communication with the UE 10 with a quantity of base stations of the second network 21 that are in communication with the UE 10. The processor 30 may determine to measure positioning signals from the first network 11 in response to determining that the quantity of base stations of the first network 11 in communication with the UE 10 is greater than the quantity of base stations of the second network 21 in communication with the UE 10.

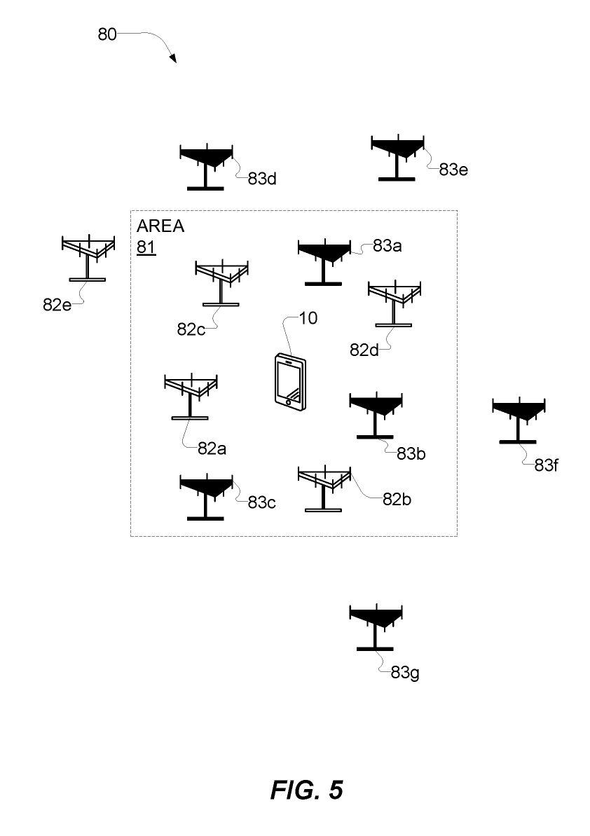

Another example of a positioning-quality value is a density of base stations in the vicinity of the UE 10. A density of base stations for a wireless network may be a number of base stations within a particular area. The area may be an area of a particular radius around the UE 10, a rectangular area with the UE 10 at the center, the current tile in which the UE 10 is located, or multiple tiles near the UE 10, etc. Referring to FIG. 5, with further reference to FIGS. 1-4, the UE 10 operates within an example communications environment 80, which includes base stations 82a-e (collectively referred to as base stations 82) and base stations 83a-g (collectively referred to as base stations 83). The base stations 82 are the base stations of the first network 11 that are in communication with the UE 10, and the base stations 83 are the base stations of the second network 21 that are in communication with UE 10. The UE 10 is in the middle of an area 81, which for the illustrated example may be considered the current tile in which the UE 10 is located. The processor 30 of the UE 10 may be configured to determine which base stations to measure positioning signals from in order to perform a positioning technique based on the density of base stations within the area 81. The position of each of the base stations 82, 83 is obtained by the UE 10 from the first assistance data and the second assistance data, which is included in the tile information received from the tile information server 27. The processor 30 is configured to determine, using the position information, the density of the base stations 82, 83 within the area 81 for each network. For example, as illustrated in FIG. 5, the first network 11 includes four base stations (the base stations 82a-d) in the area 81 and the second network 21 includes three base stations (the base stations 83a-c) in the area 81. Consequently, the density of the base stations 82 for the first network 11 in the area 81 is greater than the density of the base stations 83 for the second network 21 in the area 81. The processor 30 is configured to determine to measure positioning signals received from the base stations 82a-d of the first network 11 in response to determining that the density of the base stations 82 for the first network 11 in the area 81 is greater than the density of the base stations 83 for the second network 21 in the area 81.

Referring still to FIG. 5, the processor 30 may determine to measure positioning signals from base stations of the first network 11 when a first positioning-quality value is used and determine to measure positioning signals from base stations of the second network 21 when a second positioning-quality value is used. In particular, the processor 30 would make a different determination of base stations to use for positioning in the example communication environment 80 if the total quantity of base stations in communication with the UE 10 is used as the positioning-quality value rather than the density of base stations within the area 81. The UE 10 is in communication with five base stations (base stations 82a-e) of the first network 11 and seven base stations (base stations 83a-g) of the second network 21. Consequently, the processor 30 determines to make measurements of positioning signals received from base stations of the second network 21 when using the quantity of base stations in communication with the UE 10 to estimate the quality of the result of a positioning technique. On the other hand, there are four base stations (82a-d) of the first network 11 and three base stations (83-a-c) of the second network 21 within the area 81. Consequently, the processor 30 determines to make measurements of positioning signals received from base stations of the first network 11 when using the density of base stations within the area 81 to estimate the quality of the result of a positioning technique.

Another example of a positioning-quality value is a location-error estimate for each of the networks available to the UE 10. The location-error estimate is an estimate of the error that will result from determining the location of the UE 10 based on a particular arrangement of base stations. The location-error estimate may be calculated for any set of base stations based on the location of each of the base stations in the set of base stations relative to the location of the UE 10. An example of the location-error estimate is a geometrical dilution of precision (GDOP), which is a measure of location error that depends on the position of the UE 10 relative to the geometry (e.g., the relative locations) of the base stations expected to be used to determine the location of the UE 10. The total location error is the location error that results from performing measurements of positioning signals received from a particular set of base stations, and is a function of the GDOP and the error in the time of arrival measurements made by the UE 10. As an example, the processor 30 is configured to determine, based on the position information in the respective assistance data, a first location-error estimate for a first set of base stations (e.g., the base stations of the first network 11 for which information was included in the first assistance data received from the tile information server 27) and determine a second location-error estimate for a second set of base stations (e.g., the base stations of the second network 21 for which information was included in the second assistance data received from the tile information server 27). The processor 30 is configured to determine to measure positioning signals from the base stations that yield a lower location-error estimate. For example, the processor 30 may determine that the first location-error estimate based on the base stations of the first wireless network 11 is less than the second location-error estimate based on the base stations of the second wireless network 21. In this example, the processor 30 will determine, based on the first location-error estimate being less than the second location-error estimate, to measure positioning signals from the base stations of the first network 11 in order to perform the positioning technique.

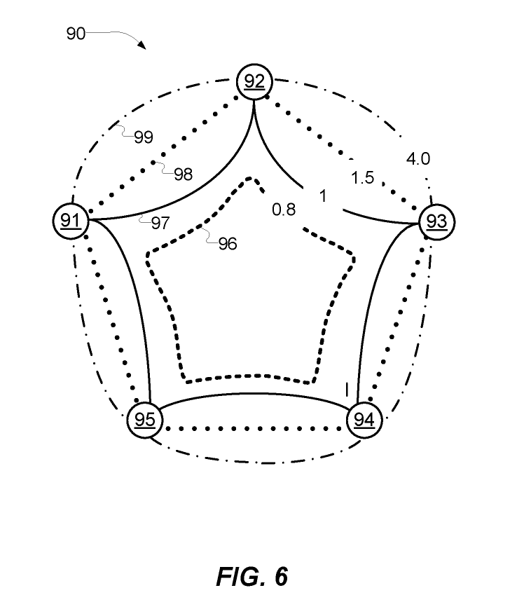

Referring to FIG. 6, an environment 90 that includes a set of five base stations 91-95 arranged as shown provides a GDOP that varies as a function of position within the environment 90 as shown. The GDOP for the particular arrangement illustrated in FIG. 5 decreases for positions approaching a center of the five base stations 91-95 and increases for positions farther away from the center of the five base stations 91-95. Four different lines plotted as a function of position in the environment 90 represent contour lines of constant GDOP. A first contour line 96 (illustrated with dashed line) represents positions within the environment 90 where the GDOP has a value of 0.8. A second contour line 97 (illustrated with a solid line) represents locations within the environment 90 where the GDOP has a value of 1.0. A third contour line 98 (illustrated with a dotted line) represents locations within the environment 90 where the GDOP has a value of 1.5. A fourth contour line 99 (illustrated with a dash-dot line) represents locations within the environment 90 where the GDOP has a value of 4.0. Thus, the GDOP estimated by the processor 30 of the UE 10 will depend on the location of the UE 10 relative to the base stations. Moreover, base stations from the first network 11 will likely result in a different estimate of GDOP than base stations from the second network 21. The processor 30 may use the estimated GDOPs for the networks as position-quality values for the purpose of determining which network to use to determine the location of the UE 10.

Referring back to FIG. 2, with further reference to FIGS. 1 and 3-6, the processor 30 may be further configured to select a measurement receiver, from among the receivers of the UE 10, to measure the positioning signals received from the base stations of the first network 11. The measurement receiver may be any of the receivers of the UE 10 that is capable of measuring signals from the first network 11 using the first SIM 36. For example, the first primary transceiver 33, which is dedicated to the first SIM 36, or the carrier aggregation transceiver 35, which is a transceiver shared by the first SIM 36 and the second SIM 37. The processor 30 may select the carrier aggregation transceiver 35 as the measurement receiver regardless of whether the first network 11 is capable of performing carrier aggregation. Thus, even if the first network 11 is incapable of implementing carrier aggregation techniques to increase the data throughput to and/or from the UE 10, the carrier aggregation transceiver 35 may be used by the UE 10 to measure positioning signals from the base stations of the first network 11. By selecting the carrier aggregation transceiver 35 to perform the measurement of positioning signals, the first primary transceiver 33 is kept available to send and/or receiver voice and/or multimedia data without utilizing some of the limited bandwidth of the first primary transceiver 33 to measure positioning signals.

The processor 30 is further configured to control the measurement receiver and the first SIM 36 to measure one or more positioning signals from the first network 11. The measurement receiver is whichever receiver is selected by the processor 30 to perform the measurement. The processor 30 may control the measurement receiver by sending instructions to the measurement receiver via the bus 38. For example, the processor 30 may use the first assistance data to determine when a positioning signal is expected to arrive and on which frequency channel the positioning signal will be received. The processor 30 is configured to send instructions to the measurement receiver to tune to an expected frequency channel at the expected time of arrival in order to receive the positioning signal.

The processor 30 may be further configured to disable measurements of positioning signals from base stations of the second network 21 using the second SIM 37 in response to a determination to measure the positioning signals from the base stations of the first network 11. By disabling the positioning signal measurements of the second network 21, the processor 30 reduces power consumption of the UE 10.

In a conventional UE 10, the dedicated data connection would be used to perform positioning signal measurements. For example, a conventional UE 10 would automatically use the second primary receiver 34 and the second SIM 37, which were previously designated to implement the dedicated data connection for the UE 10, to implement the positioning technique to determine the location of the UE 10 without evaluating whether a different subscription would be better to use. In contrast, the UE 10 of the present disclosure may intelligently select which network to use for the positioning technique. The processor 30 of the UE 10 may be configured to establish a dedicated data connection with the second network 21 using the second SIM 37. The processor 30 is further configured to maintain the dedicated data connection with the second network 21 using the second SIM 37 in response to a determination to measure the positioning signals from the base stations of the first network 11. Thus, the UE 10 is capable of maintaining the dedicated data connection while performing a positioning technique to determine the location of the UE 10.

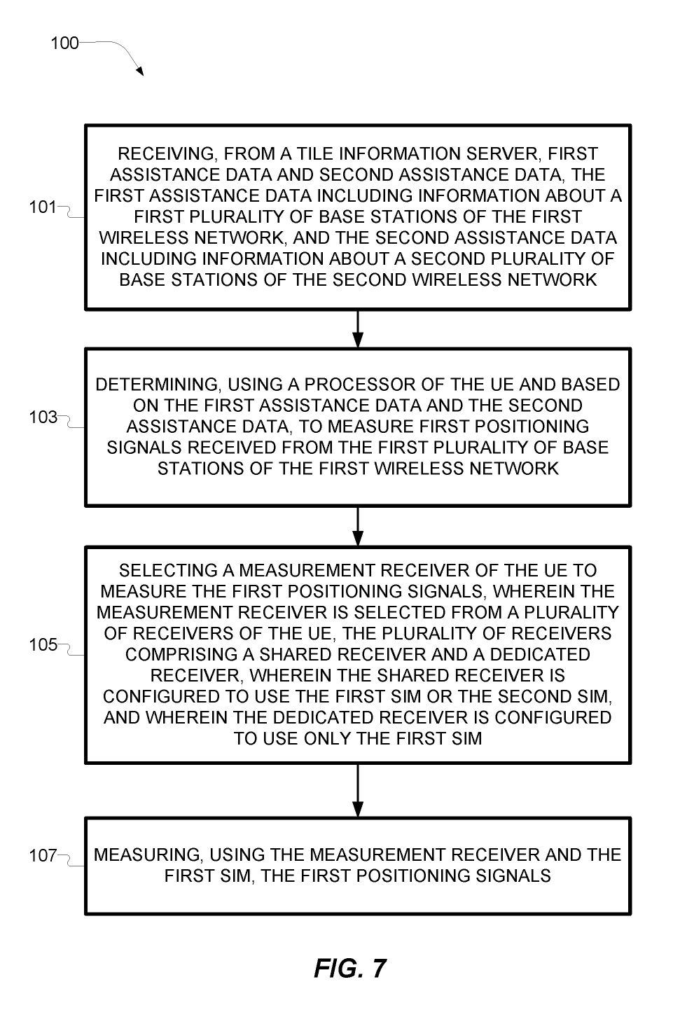

Referring to FIG. 7, with further reference to FIGS. 1-6, a method 100 of operating a UE that includes a first SIM for communicating with a first wireless network and a second SIM for communicating with a second wireless network includes the stages shown. The method 100 can be altered, e.g., by having stages added, removed, rearranged, combined, performed concurrently, and/or having single stages split into multiple stages.

The method 100 includes, at stage 101, receiving, from a tile information server, first assistance data and second assistance data, the first assistance data including information about first base stations of the first wireless network, and the second assistance data including information about second base stations of the second wireless network. The first assistance data and the second assistance data may be included in tile information 60 sent from the tile information server 27 to the UE 10 via the first network 11, the second network 21 or via some other wireless network in communication with the UE 10. The first assistance data and the second assistance data may, for example, include the first wireless network information 61 and the second wireless network information 62, respectively. The first assistance data and the second assistance data may be received by one of the transceivers 33-35 via one of the antennas 39-41. The first assistance data and the second assistance data may be sent to the processor 30 and/or the memory 31 for use in performing a positioning technique to determine the location of the UE 10.

The method 100 includes, at stage 103, determining, using a processor of the UE and based on the first assistance data and the second assistance data, to measure first positioning signals received from the first base stations of the first wireless network. For example, the processor 30 may determine to measure positioning signals received from base stations of the first network 11 based on an analysis of the first assistance data and the second assistance data that is, for example, included in the received tile information 60. To determine whether to measure positioning signals from the first network 11 or positioning signals from the second network 21, the processor 30 may use a metric to compare the expected performance of the positioning technique for the two networks. An example metric may be a positioning-quality value used by the UE 10 to determine which wireless network is likely to result in a higher quality result from a positioning technique. An example positioning-quality value may be a quantity of base stations of a respective network. The processor 30 may use the first assistance data and the second assistance data to determine that the first network 11 has fewer base stations than the second network 21. Based on this determination, the processor 30 may determine to measure the positioning signals received from the base stations of the second network 21 rather than measure the positioning signals received from the base stations of the first network 11. The quantity of base stations may be a total number of base stations, a number of base stations the UE 10 receives signals from, a number of base station in communication with the UE 10, or some other quantity of base stations.

Another example of a positioning-quality value is a density of base stations in the vicinity of the UE 10. A density of base stations for a wireless network may be a number of base stations within a particular area. The area may be an area of a particular radius around the UE 10, a rectangular area with the UE 10 at the center, the current tile at which the UE 10 is located, or multiple tiles near the UE 10. The position of each of the base stations is obtained by the UE 10 from the first assistance data and the second assistance data, which may be included in the tile information received from the tile information server 27. When selecting a wireless network to use from multiple available networks, the processor 30 selects the wireless network with the highest density for use in performing the positioning technique. For example, the processor 30 may determine to measure positioning signals received from the base stations of the first wireless network in response to determining that the density of base stations for the first network 11 is greater than the density of base stations for the second network 21.

Another example of a positioning-quality value is a location-error estimate for each of the networks available to the UE 10. The location-error estimate, such as GDOP, may be calculated for any set of base stations based on the location of each of the base stations in the set of base stations. When selecting a wireless network to use from multiple available networks, the processor 30 selects the wireless network with the lowest location-error estimate. As an example, the processor 30 determines a first location-error estimate for a first set of base stations (e.g., the base stations of the first network 11 for which information was included in the first assistance data received from the tile information server 27) and determines a second location-error estimate for a second set of base stations (e.g., the base stations of the second network 21 for which information was included in the second assistance data received from the tile information server 27). The processor 30 may determine that the first location-error estimate based on the base stations of the first wireless network 11 is less than the second location-error estimate based on the base stations of the second wireless network 21. The processor 30 determines, based on the first location-error estimate being less than the second location-error estimate, to measure positioning signals from the base stations of the first network 11 in order to perform the positioning technique.

The method 100 includes, at stage 105, selecting a measurement receiver of the UE to measure the first positioning signals, the measurement receiver being selected from multiple receivers of the UE, the multiple receivers including a shared receiver and a dedicated receiver. The shared receiver is configured to use the first SIM or the second SIM, and the dedicated receiver is configured to use only the first SIM. For example, the processor 30 of the UE 10 may select one of transceivers 33-35 to measure the positioning signals received from the first network 11. Because the second primary transceiver 34 is dedicated to the second SIM and the second network 21, the second primary transceiver 34 may not be selected for measuring positioning signals from the first network 11. However, a dedicated transceiver, such as the first primary transceiver 33, or a shared transceiver, such as the carrier aggregation receiver 35 may be selected for measuring the positioning signals received from base station of the first network 11.

The method 100 includes, at stage 107, measuring, using the measurement receiver and the first SIM, the first positioning signals. For example, if the carrier aggregation transceiver 35 is selected by the processor 30 to be the measurement receiver, then the processor 30 sends instructions via the bus 38 for the carrier aggregation transceiver 35 to tune to a particular frequency channel at a particular time to measure the incoming positioning signal. The particular time and frequency channel sent to the carrier aggregation transceiver 35 may be based on, for example, the timing information 69 and the frequency channel information 70, respectively, included in the first assistance data (e.g., the first wireless network information 61).

The method 100 may include additional stages not shown in FIG. 7. For example, The UE 10 may disable measurements of second positioning signals using the second SIM in response to the determining to measure the first positioning signals. The second positioning signals are received from the second base stations of the second wireless network. For example, in response to the UE 10 determining that the positioning signals from the first network 11 are to be measured, the UE 10 can prevent the measurement of positioning signals received from the second network 21 in order to reduce the power consumed by the UE 10. Additionally, the UE 10 may establish a dedicated data connection with the second network 21 using the second SIM 37. The processor 30 may maintain the dedicated data connection with the second network 21 using the second SIM 37 in response to a determination to measure the positioning signals from the base stations of the first network 11. Thus, the UE 10 is capable of maintaining the dedicated data connection while performing a positioning technique to determine the location of the UE 10.

### OTHER CONSIDERATIONS

Other examples and implementations are within the scope and spirit of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C,” or “A, B, or C, or a combination thereof” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

A wireless network is a communications system in which communications are conveyed wirelessly, i.e., by electromagnetic and/or acoustic waves propagating through atmospheric space rather than through a wire or other physical connection. A wireless network may not have all communications transmitted wirelessly, but is configured to have at least some communications transmitted wirelessly.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The terms “processor-readable medium” as used herein, refer to any medium that participates in providing data that causes a machine to operate in a specific fashion. Using a processor of a computer system, various processor -readable media might be involved in providing instructions/code to processor(s) for execution and/or might be used to store and/or carry such instructions/code (e.g., as signals). In many implementations, a processor-readable medium is a physical and/or tangible storage medium and does not include transitory, propagating signals. Such a medium may take many forms, including but not limited to, non-volatile media and volatile media. Non-volatile media include, for example, optical and/or magnetic disks. Volatile media include, without limitation, dynamic memory.

Common forms of physical and/or tangible processor-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of processor-readable media may be involved in carrying one or more sequences of one or more instructions to one or more processors for execution. Merely by way of example, the instructions may initially be carried on a magnetic disk and/or optical disc of a remote computer. A remote computer might load the instructions into its dynamic memory and send the instructions as signals over a transmission medium to be received and/or executed by a computer system.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, some operations may be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof When implemented in software, firmware, middleware, or microcode, the program code or code segments to perform the tasks may be stored in a non-transitory processor-readable medium such as a storage medium. Processors may perform one or more of the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

Further, more than one invention may be disclosed.

What is claimed is:

1. A method of operating a user equipment (UE) that includes a first subscriber identification module (SIM) for communicating with a first wireless network and a second SIM for communicating with a second wireless network, the method comprising:
receiving, from a tile information server, first assistance data and second assistance data, wherein the first assistance data includes information about a first plurality of base stations of the first wireless network, and wherein the second assistance data includes information about a second plurality of base stations of the second wireless network;
determining, using a processor of the UE and based on the first assistance data and the second assistance data, to measure first positioning signals received from the first plurality of base stations of the first wireless network;
selecting a measurement receiver of the UE to measure the first positioning signals, wherein the measurement receiver is selected from a plurality of receivers of the UE, the plurality of receivers comprising a shared receiver and a dedicated receiver, wherein the shared receiver is configured to use the first SIM or the second SIM, and wherein the dedicated receiver is configured to use only the first SIM; and
measuring, using the measurement receiver and the first SIM, the first positioning signals.

2. The method of claim 1, wherein the determining to measure the first positioning signals is based on determining that a first positioning-quality value of the first wireless network is greater than a second positioning-quality value of the second wireless network.

3. The method of claim 2, wherein the determining that the first position-quality value is greater than the second positioning-quality value comprises determining that a quantity of the first plurality of base stations is greater than a quantity of the second plurality of base stations.

4. The method of claim 3, wherein the determining that the quantity of the first plurality of base stations is greater than the quantity of the second plurality of base stations comprises determining that a first quantity of the first plurality of base stations within an area in which the UE is located is greater than a second quantity of the second plurality of base stations within the area in which the UE is located.

5. The method of claim 2, wherein the determining that the first position-quality value is greater than the second positioning-quality value comprises determining that a first location-error estimate based on the first plurality of base stations is less than a second location-error estimate based on the second plurality of base stations.

6. The method of claim 1, further comprising disabling measurements of second positioning signals using the second SIM in response to the determining to measure the first positioning signals, wherein the second positioning signals are received from the second plurality of base stations of the second wireless network.

7. The method of claim 1, wherein the selecting the measurement receiver comprises selecting the dedicated receiver that is dedicated to the first SIM.

8. The method of claim 1, wherein the selecting the measurement receiver to measure positioning signals comprises selecting the shared receiver, wherein the shared receiver is a carrier aggregation receiver of the UE configured to receive carrier aggregation signals from the first wireless network or the second wireless network.

9. The method of claim 1, wherein the receiving the first assistance data and the second assistance data comprises receiving location information for each base station of the first plurality of base stations and location information for each base station of the second plurality of base stations.

10. The method of claim 1, further comprising:
establishing a dedicated data connection with the second wireless network using the second SIM; and
maintaining the dedicated data connection with the second wireless network using the second SIM in response to the determining to measure the first positioning signals.

11. A user equipment (UE) comprising:
a first subscriber identity module (SIM) configured to provide information that facilitates communication with a first wireless network;
a second SIM configured to provide information that facilitates communication with a second wireless network;
a plurality of receivers comprising:
a first receiver configured to receive information from the first wireless network using the first SIM;
a second receiver configured to receive information from the second wireless network using the second SIM; and
a shared receiver configured to receive information from the first wireless network using the first SIM and configured to receive information from the second wireless network using the second SIM;
a processor, communicatively coupled to the first receiver, the first SIM, the second receiver and the second SIM, configured to:
receive, from a tile information server, first assistance data and second assistance data, wherein the first assistance data includes information about a first plurality of base stations of the first wireless network, and wherein the second assistance data includes information about a second plurality of base stations of the second wireless network;
determine, based on the first assistance data and the second assistance data, to measure first positioning signals received from the first plurality of base stations of the first wireless network;
select a measurement receiver, from among the plurality of receivers, to measure the first positioning signals; and
control the measurement receiver and the first SIM to measure the first positioning signals.

12. The UE of claim 11, wherein the processor is configured to determine to measure the first positioning signals based on a determination that a first positioning-quality value of the first wireless network is greater than a second positioning-quality value of the second wireless network.

13. The UE of claim 12, wherein the processor is configured to determine that the first position-quality value is greater than the second positioning-quality value by determining that a quantity of the first plurality of base stations is greater than a quantity of the second plurality of base stations.

14. The UE of claim 13, wherein the processor is configured to determine that the quantity of the first plurality of base stations is greater than the quantity of the second plurality of base stations by determining that a first quantity of the first plurality of base stations within an area in which the UE is located is greater than a second quantity of the second plurality of base stations within the area in which the UE is located.

15. The UE of claim 12, wherein the processor is configured to determine that the first position-quality value is greater than the second positioning-quality value by determining that a first location-error estimate based on the first plurality of base stations is less than a second location-error estimate based on the second plurality of base stations.

16. The UE of claim 11, wherein the processor is further configured to disable measurements of second positioning signals using the second SIM in response to a determination to measure the first positioning signals, wherein the second positioning signals are received from the second plurality of base stations of the second wireless network.

17. The UE of claim 11, wherein the processor is configured to select the first receiver as the measurement receiver.

18. The UE of claim 11, wherein:
the shared receiver comprises a carrier aggregation receiver configured to receive carrier aggregation signals from the first wireless network or the second wireless network; and
the processor is configured to select the carrier aggregation receiver as the measurement receiver.

19. The UE of claim 11, wherein to receive the first assistance data and the second assistance data the processor is configured to receive location information for each base station of the first plurality of base stations and location information for each base station of the second plurality of base stations.

20. The UE of claim 11, wherein the processor is further configured to:
establish a dedicated data connection with the second wireless network using the second SIM; and
maintain the dedicated data connection with the second wireless network using the second SIM in response to a determination to measure the first positioning signals.

21. A user equipment (UE) comprising:
a first subscriber identity module (SIM) configured to provide information that facilitates communication with a first wireless network;
a second SIM configured to provide information that facilitates communication with a second wireless network;
a plurality of receivers comprising:
a first receiver configured to receive information from the first wireless network using the first SIM;
a second receiver configured to receive information from the second wireless network using the second SIM; and
a shared receiver configured to receive information from the first wireless network using the first SIM and configured to receive information from the second wireless network using the second SIM;
means for receiving, from a tile information server, first assistance data and second assistance data, wherein the first assistance data includes information about a first plurality of base stations of the first wireless network, and wherein the second assistance data includes information about a second plurality of base stations of the second wireless network;
means for determining, based on the first assistance data and the second assistance data, to measure first positioning signals received from the first plurality of base stations of the first wireless network;
means for selecting a measurement receiver, from among the plurality of receivers, to measure the first positioning signals; and
means for controlling the measurement receiver and the first SIM to measure the first positioning signals.

22. The UE of claim 21, wherein the means for determining to measure the first positioning signals comprise means for determining that a first positioning-quality value of the first wireless network is greater than a second positioning-quality value of the second wireless network.

23. The UE of claim 21, further comprising means for disabling measurements of second positioning signals using the second SIM in response to a determination to measure the first positioning signals, wherein the second positioning signals are received from the second plurality of base stations of the second wireless network.

24. The UE of claim 21, wherein:
the shared receiver comprises a carrier aggregation receiver configured to receive carrier aggregation signals from the first wireless network or the second wireless network; and
the means for selecting the measurement receiver include means for selecting the carrier aggregation receiver as the measurement receiver.

25. The UE of claim 21, further comprising:
means for establishing a dedicated data connection with the second wireless network using the second SIM; and
means for maintaining the dedicated data connection with the second wireless network using the second SIM in response to a determination to measure the first positioning signals.

26. A non-transitory processor-readable storage medium comprising processor-readable instructions configured to cause a processor of a user equipment (UE), which includes a first subscriber identification module (SIM) for communicating with a first wireless network and a second SIM for communicating with a second wireless network, to:
receive, from a tile information server, first assistance data and second assistance data, wherein the first assistance data includes information about a first plurality of base stations of the first wireless network, and wherein the second assistance data includes information about a second plurality of base stations of the second wireless network;
determine, based on the first assistance data and the second assistance data, to measure first positioning signals received from the first plurality of base stations of the first wireless network;
select a measurement receiver of the UE to measure the first positioning signals, the plurality of receivers comprising a shared receiver and a dedicated receiver, wherein the shared receiver is configured to use the first SIM or the second SIM, and wherein the dedicated receiver is configured to use only the first SIM; and
control the measurement receiver and the first SIM to measure the first positioning signals.

27. The non-transitory processor-readable storage medium of claim 26, wherein the instructions configured to cause the processor to determine to measure the first positioning signals include instructions configured to cause the processor to determine that a first positioning-quality value of the first wireless network is greater than a second positioning-quality value of the second wireless network.

28. The non-transitory processor-readable storage medium of claim 26, further comprising instructions configured to cause the processor to disable measurements of second positioning signals using the second SIM in response to a determination to measure the first positioning signals, wherein the second positioning signals are received from the second plurality of base stations of the second wireless network.

29. The non-transitory processor-readable storage medium of claim 25, wherein the instructions configured to cause the processor to select the measurement receiver include instructions configured to cause the processor to selecting the shared receiver as the measurement receiver, wherein the shared receiver is a carrier aggregation receiver configured to receive carrier aggregation signals from the first wireless network or the second wireless network.

30. The non-transitory processor-readable storage medium of claim 25, further comprising instructions configured to cause the processor to:
establish a dedicated data connection with the second wireless network using the second SIM; and
maintain the dedicated data connection with the second wireless network using the second SIM in response to a determination to measure the first positioning signals.
